(19) United States
(12) Patent Application Publication
(10) Pub. No.: US 2014/0012803 A1
(43) Pub. Date: Jan. 9, 2014

(54) EVENT ANALYSIS APPARATUS, EVENT ANALYSIS METHOD, AND COMPUTER-READABLE RECORDING MEDIUM

(71) Applicants: Takao Kawai, Tokyo (JP); Satoshi Nakazawa, Tokyo (JP)

(72) Inventors: Takao Kawai, Tokyo (JP); Satoshi Nakazawa, Tokyo (JP)

(73) Assignee: NEC CORPORATION, Minato-ku, Tokyo (JP)

(21) Appl. No.: 14/006,810

(22) PCT Filed: Feb. 22, 2012
(86) PCT No.: PCT/JP2012/054222

§ 371 Date: Sep. 23, 2013

(30) Foreign Application Priority Data
Mar. 23, 2011 (JP) 2011-063766

(51) Int. Cl. G06F 17/30

(52) U.S. Cl. CPC G06F 17/30011
USPC 707/608

(57) ABSTRACT

In order to analyze an event described in a document targeted for analysis, an event analysis apparatus (100) includes: a constituent element identification unit (101) that identifies a description related to the event from the document targeted for analysis, and identifies a situational expression indicating a situation and a corresponding expression associated with the situational expression from the identified description; and a shared state analysis unit (102) that calculates a share degree indicating the possibility that the event to which the identified description is related is shared by a plurality of people based on the identified situational expression and corresponding expression.

### TECHNICAL FIELD

The present invention relates to an event analysis apparatus, and in particular to an event analysis apparatus used in the analysis of events that attract public interest. The present invention also relates to an event analysis method and a computer-readable recording medium.

### BACKGROUND ART

Along with the dissemination of the Internet, not only news distribution by some news media such as newspaper publishers and television stations, but also web documents in which many people comment about various events, have been made publicly available in large numbers on the Internet. Events mentioned herein refer to various happenings that occur in the world, and are not necessarily limited to things such as crimes and accidents (note that events may also be referred to as “occurrences” below). Events include performances held in arbitrary places, festivals, natural phenomena that occurred in a specific areas, behaviors of a specific person, and the like.

Web documents describe a wide variety of things and have been issued in large numbers. At present, contents of web documents are not limited to contents covered by news reports by news media. That is to say, web documents also contain a large amount of information that is irrelevant to many people. Therefore, in order to analyze events that are attracting public interest and hence are mutually discussed by many people using web documents, some sort of means is necessary that extracts information related to events that are attracting public interest from random pieces of information that are not appropriate as topics.

To respond to the above demand, Non-Patent Document 1 discloses one example of a conventional technique for analyzing events that are attracting public interest. The technique disclosed in Non-Patent Document 1 first counts the appearance frequencies of keywords from a plurality of web documents on the Internet, such as blogs and electronic bulletin boards, and evaluates any sudden increase in the number of documents during a certain time period. The technique disclosed in Non-Patent Document 1 then assigns, to the keywords, burst degrees indicating the extent of attraction of interest during the certain time period based on the evaluation.

The technique disclosed in Non-Patent Document 1 extracts keywords that are assigned high burst degrees, and determines that the extracted keywords represent topics that are attracting interest. As described above, according to the technique disclosed in Non-Patent Document 1, one or more keywords that have a possibility of being related to topics that attracted interest during a specific time period can be obtained, and therefore analysis of those events that occurred during the specific time period is expected.

### CITATION LIST

### Non-Patent Document

Non-Patent Document 1: Toshiaki FUJIKI, Tomoyuki NANNO, Yasuhiro SUZUKI and Manabu OKUMURA. “Identification of Bursts in a Document Stream.” Information Processing Society of Japan, Research Report in Natural Language Processing. 2004-NL-160-(13). Pages 85 to 92. Mar. 4, 2004.

25

### DISCLOSURE OF THE INVENTION

### Problem to be Solved by the Invention

However, the above technique disclosed in Non-Patent Document 1 does not take into consideration the background behind the bursts of keywords during a specific time period. Therefore, in the case where the appearance frequencies of certain keywords increase by chance during a specific time period, the above technique disclosed in Non-Patent Document 1 also extracts keywords that are not related to topics that are attracting interest. As a result, the problem arises that events cannot be analyzed with high accuracy even with the use of the above technique disclosed in Non-Patent Document 1. This is described in detail below.

For example, assume that keywords such as “train” and “car” frequently appear in a group of documents on websites such as blogs, microblogs, electronic bulletin boards and diary sites on the Internet during an hour one morning.

If that hour is during a time period in which many people commute to work, school or the like, then there will be a variety of documents containing descriptions about trains, such as “I missed my train,” “the train I am on got in an accident,” “I am waiting for a train,” and “it is about time my son got on a train.”

It is considered that documents containing descriptions about general trains are not necessarily attributed to one common event such as a specific crime or accident, but are rather written as a result of various events occurring to different individuals.

Therefore, when the technique disclosed in Non-Patent Document 1 is used to perform the analysis in relation to a time period in which many people commute to work or school according to societal practice, the keyword “train” could be presented at any time. What is more, this keyword does not refer to a topic that is attracting interest, but refers to various events.

To be more specific, in general, web documents related to a topic that attracts public attention and interest as news are often written based on one common event. However, the technique disclosed in Non-Patent Document 1 does not take into consideration such a common event at all. That is to say, the technique disclosed in Non-Patent Document 1 merely calculates and uses the frequencies of keywords in documents written during a specific time period. If these documents are actually related to different events but are written using the same keyword, this keyword is processed as a keyword with a high burst degree.

Therefore, in the case where a plurality of documents describing different events contain the same keyword in large numbers by chance, the technique disclosed in Non-Patent Document 1 extracts this keyword in a manner similar to keywords related to events that are attracting interest.

In view of the above, analysis of events in consideration of whether or not the events are attracting interest from a plurality of people is desired. In other words, when extracting information that is attracting interest from an input group of documents, extraction and counting of keywords in consideration of whether the keywords are related to events that are shared and hence mutually discussed by many people, or are related to random discrete events of different subjects are desired.

### OBJECT OF INVENTION

It is an object of the present invention to provide an event analysis apparatus, an event analysis method and a computer-readable recording medium that can solve the above problem by analyzing events using documents in consideration of whether or not the events are of common interest to a plurality of people.

### Means for Solving the Problem

In order to achieve the above object, an event analysis apparatus according to one aspect of the present invention analyzes an event described in a document targeted for analysis. The event analysis apparatus includes: a constituent element identification unit that identifies a description related to an event from the document targeted for analysis, and identifies a situational expression indicating a situation and a corresponding expression associated with the situational expression from the identified description; and a shared state analysis unit that calculates a share degree indicating the possibility that the event to which the description is related is shared by a plurality of people based on the situational expression and the corresponding expression identified from the description.

In order to achieve the above object, an event analysis method according to one aspect of the present invention analyzes an event described in a document targeted for analysis. The event analysis method includes: (a) a step of identifying a description related to an event from the document targeted for analysis, and identifying a situational expression indicating a situation and a corresponding expression associated with the situational expression from the identified description; and (b) a step of calculating a share degree indicating the possibility that the event to which the description is related is shared by a plurality of people based on the situational expression and the corresponding expression identified from the description.

In order to achieve the above object, a computer-readable recording medium according to one aspect of the present invention has recorded therein a program for analyzing an event described in a document targeted for analysis using a computer. The program includes an instruction for causing the computer to execute: (a) a step of identifying a description related to an event from the document targeted for analysis, and identifying a situational expression indicating a situation and a corresponding expression associated with the situational expression from the identified description; and (b) a step of calculating a share degree indicating the possibility that the event to which the description is related is shared by a plurality of people based on the situational expression and the corresponding expression identified from the description.

### Effect of the Invention

As set forth above, the present invention allows analyzing of events using documents in consideration of whether or not the events are of common interest to a plurality of people.

### BRIEF DESCRIPTION OF THE DRAWINGS

FIG. 1 is a block diagram showing a schematic configuration of an event analysis apparatus according to Embodiment 1 of the present invention.

FIG. 2 is a flow diagram showing the operations of the event analysis apparatus according to Embodiment 1 of the present invention.

FIG. 3 shows examples of situational expressions identified from event descriptions and corresponding expressions associated therewith in Embodiment 1 of the present invention.

FIG. 4 shows examples of rules used in calculating share degrees in Embodiment 1 of the present invention.

FIG. 5 is a block diagram showing a schematic configuration of an event analysis apparatus according to Embodiment 2 of the present invention.

FIG. 6 is a flow diagram showing the operations of the event analysis apparatus according to Embodiment 2 of the present invention.

FIG. 7 is a block diagram showing one example of a computer that realizes the event analysis apparatuses according to Embodiments 1 and 2 of the present invention.

### DESCRIPTION OF EMBODIMENTS

### Embodiment 1

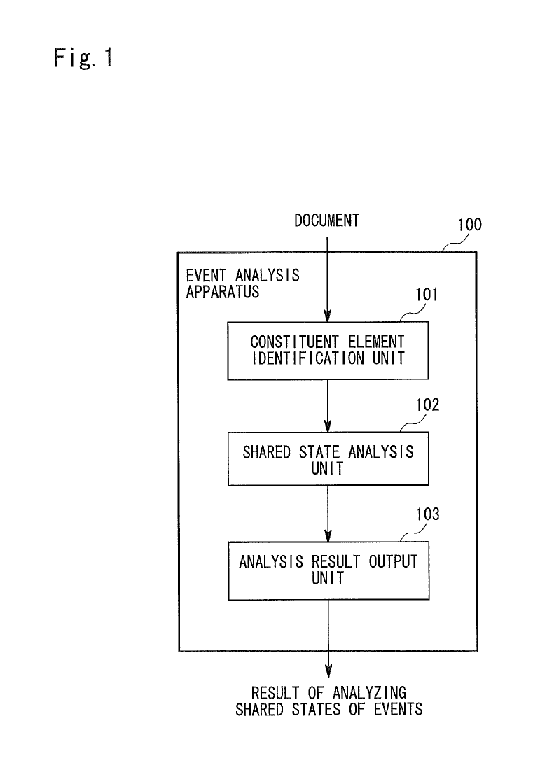

The following describes an event analysis apparatus and an event analysis method according to Embodiment 1 of the present invention with reference to FIGS. 1 to 4. While Embodiment 1 of the present invention is described below, the present invention is by no means limited to the following Embodiment 1.

Apparatus Configuration

First, a description is given of a configuration of the event analysis apparatus according to Embodiment 1 of the present invention with reference to FIG. 1. FIG. 1 is a block diagram showing a schematic configuration of the event analysis apparatus according to Embodiment 1 of the present invention.

An event analysis apparatus 100 according to the present Embodiment 1 shown in FIG. 1 analyzes an event described in a document targeted for analysis. As shown in FIG. 1, the event analysis apparatus 100 includes a constituent element identification unit 101 and a shared state analysis unit 102.

The constituent element identification unit 101 receives a document targeted for analysis from outside, and identifies descriptions related to an event (hereinafter referred to as “event descriptions”) from the received document. The constituent element identification unit 101 also identifies, from the identified event descriptions, situational expressions that indicate situations and expressions associated with these situational expressions (hereinafter referred to as “corresponding expressions”) as constituent elements of the identified event descriptions.

Based on the situational expressions and corresponding expressions identified from the event descriptions, the shared state analysis unit 102 calculates a share degree indicating the possibility that the event to which the event descriptions are related is shared by a plurality of people, that is to say, the shared state of the event.

As described above, the event analysis apparatus 100 obtains a share degree of an event described in a document. When the share degree is high, the possibility of the target event being shared by a plurality of people is high. When the share degree is low, the possibility of the target event being shared by a plurality of people is low. In this way, the event analysis apparatus 100 allows analyzing of events using documents in consideration of whether or not the events are of common interest to a plurality of people.

Below is a more specific description of the configuration of the event analysis apparatus 100 according to the present Embodiment 1. In the present Embodiment 1, the constituent element identification unit 101 identifies, for example, a portion of an event description indicating a behavior, an action or a status as a situational expression. The constituent element identification unit 101 also identifies, for example, an expression that is related to a situational expression and represents any of a time, a place, a subject and an object as a corresponding expression.

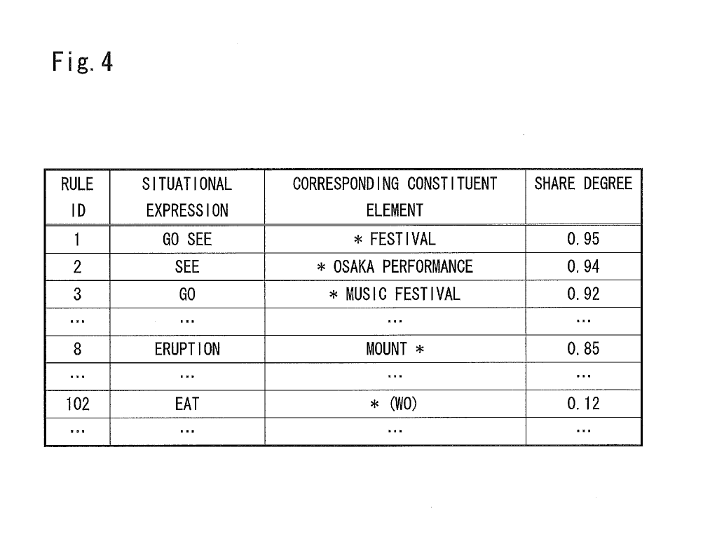

Furthermore, in the present Embodiment 1, the shared state analysis unit 102 can calculate share degrees by applying set rules to situational expressions and corresponding expressions. Here, for example, the rules define share degrees in one-to-one association with pairs each consisting of an assumed situational expression and a character string assumed as a corresponding expression (see FIG. 4).

Furthermore, the rules may define cases as character strings assumed as corresponding expressions. In this case, the shared state analysis unit 102 applies the rules when corresponding expressions match the cases defined by the rules.

Moreover, in the present Embodiment 1, the shared state analysis unit 102 may also calculate a first degree indicating the possibility that the object of a situational expression is shared by a plurality of people and a second degree indicating the possibility that a corresponding expression is related to an event, so as to calculate a share degree based on the first and second degrees.

As shown in FIG. 1, the event analysis apparatus 100 according to the present Embodiment 1 also includes an analysis result output unit 103. The analysis result output unit 103 outputs the calculated share degrees and information related to the events for which the share degrees have been calculated. Examples of the information related to the events are situational expressions and corresponding expressions. Other examples of the information related to the events are sentences containing situational expressions and corresponding expressions.

Apparatus Operations

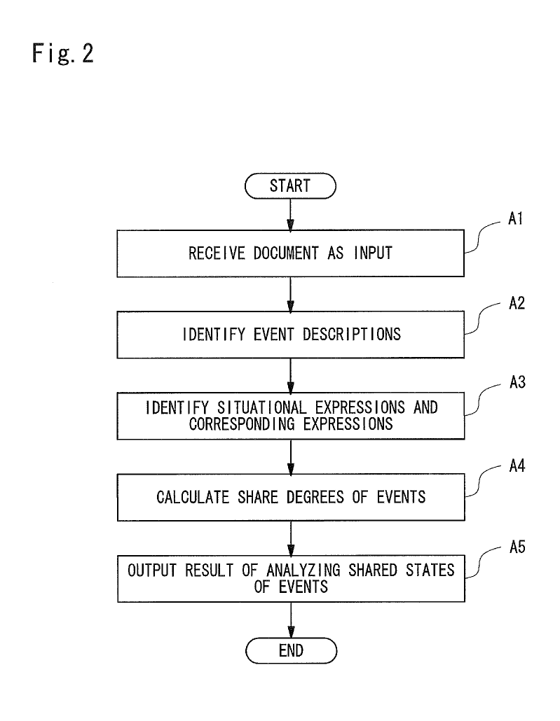

A description is now given of the operations of the event analysis apparatus 100 according to Embodiment 1 of the present invention with reference to FIG. 2. FIG. 2 is a flow diagram showing the operations of the event analysis apparatus according to Embodiment 1 of the present invention. In the following description, FIG. 1 shall be referred to where appropriate. In the present Embodiment 1, the event analysis method is implemented by causing the event analysis apparatus 100 to operate. Therefore, the following description of the operations of the event analysis apparatus 100 applies to the event analysis method according to the present Embodiment 1.

As shown in FIG. 2, the constituent element identification unit 101 first receives a document targeted for analysis as input (step A1). When a plurality of documents are received in step A1, the steps following A1 are executed for each document.

Next, for each document received, the constituent element identification unit 101 identifies one or more descriptions that are contained therein and related to events (event descriptions) (step A2).

Thereafter, the constituent element identification unit 101 identifies constituent elements that serve as situational expressions from constituent elements contained in the event descriptions, and further identifies constituent elements associated with the identified constituent elements, i.e. corresponding expressions from the event descriptions (step A3).

Subsequently, the shared state analysis unit 102 calculates share degrees indicating the shared states of events based on the situational expressions and corresponding expressions identified from the event descriptions (step A4). As a result of execution of step A4, a share degree is calculated for each event contained in the input document(s).

Then, for each event, the analysis result output unit 103 outputs to the outside the share degree calculated by the shared state analysis unit 102 and information related to the event (for example, the situational expression and corresponding expressions) as a result of analyzing the shared state of the event (step A5).

Apparatus Operations: Specific Examples

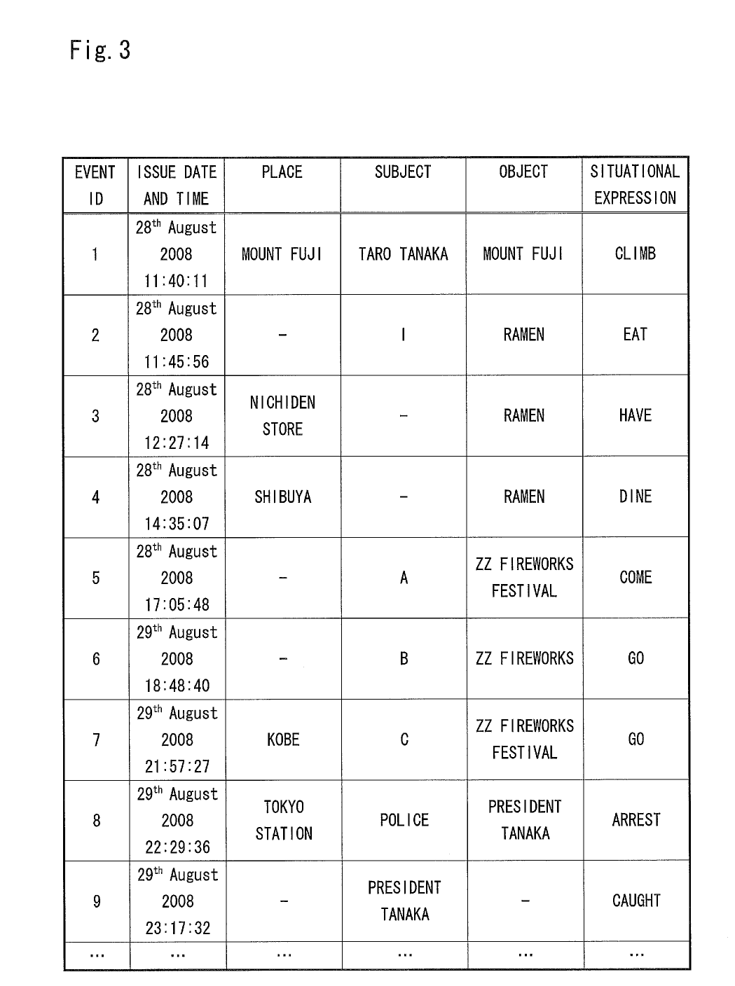

A detailed description of the above steps A1 to A5 is given below using specific examples. Note that the following description is given step-by-step with reference to FIGS. 3 and 4 in addition to FIGS. 1 and 2.

(Step A1)

In step A1, the constituent element identification unit 101 receives a document targeted for analysis as input. Here, a set of documents may be input. For example, a set of webpages may be input as a set of documents. In the case where a plurality of documents are input, the following steps A2 to A4 are executed for each document as mentioned earlier.

(Step A2)

In step A2, the constituent element identification unit 101 identifies, for each document input, event descriptions contained therein. Event descriptions can be identified by, for example, identifying descriptive portions containing at least situational expressions based on patterns of parts of speech and strings of parts of speech, which can be obtained by analyzing morphemes in the text contained in the document(s). Situational expressions are, for example, portions indicating behaviors, actions or statuses. Specific examples of situational expressions include verbs, adjectival nouns, nouns that precede verbs according to sa-row irregular conjugation, and behavioral nouns that are nouns derived from verbs.

(Step A3)

In step A3, the constituent element identification unit 101 identifies, from each event description identified in step A2, a situational expression and corresponding expressions associated therewith as constituent elements of the event description. Examples of corresponding expressions associated with situational expressions include a string of nouns adjacent to the situational expressions.

In another example, the constituent element identification unit 101 may apply parsing to the text contained in the document(s) in step A2 and identify portions indicating behaviors, actions or statuses as situational expressions based on verbs, adjectival nouns, behavioral nouns, and the like contained in predicates. In this case, in step A3, the constituent element identification unit 101 extracts elements of cases associated with the predicates based on dependency relationships, and extracts expressions containing a string of nouns, proper nouns and named entities from the elements of cases as corresponding expressions.

Furthermore, in step A3, the constituent element identification unit 110 may sort the constituent elements identified as corresponding expressions into different groups of constituent elements, such as a place, a subject and an object. FIG. 3 shows examples of situational expressions and corresponding expressions associated therewith identified from event descriptions in Embodiment 1 of the present invention. In the examples of FIG. 3, for each event description, a situational expression identified from the event description as well as corresponding expressions associated therewith, such as a place, a subject and an object, are presented.

Note that as shown in FIG. 3, one event ID is assigned to one event description, and a place, a subject, an object and a situational expression are associated with each event ID. Furthermore, for example, metadata, descriptive content, and the issue date and time of a corresponding document may be associated with each event ID. Also note that in the examples of FIG. 3, the root forms of verbs, adjectival nouns, behavioral nouns, etc. are presented as situational expressions.

Corresponding expressions representing places, subjects and objects can be extracted using, for example, particles found in the expressions containing strings of nouns adjacent to situational expressions as a clue. Corresponding expressions representing places, subjects and objects may also be extracted using the expressions, parts of speech, named entities, and the like contained in arguments that are in a corresponding relationship (e.g., dependency relationship) with predicates as a clue.

For example, when the text “Taro Tanaka climbed Mount Fuji” is targeted for analysis, the constituent element identification unit 110 extracts a place from “Mount Fuji,” a subject from “Taro Tanaka,” and an object from “Mount Fuji.” This example can be realized, for instance, by applying an existing technique to analyze the predicate-argument structure. More specifically, the predicates and arguments that are obtained as a result of analyzing the predicate-argument structure can be used as situational expressions and corresponding expressions, respectively. One or more arguments are obtained as a result of analyzing the predicate-argument structure. Each argument can be used as a corresponding expression. When the subject cannot be identified, should the subject be a pronoun such as “I,” the constituent element identification unit 110 may identify the issuer of a corresponding document identified from its metadata as the subject.

(Step A4)

In step A4, for each event description, the shared state analysis unit 102 calculates a share degree indicating the shared state of an event based on the situational expression and corresponding expressions identified in step A3. For example, the shared state analysis unit 102 calculates a share degree of an event by referring to rules that define share degrees for specific pairs each consisting of a situational expression and a corresponding expression associated therewith.

FIG. 4 shows examples of rules used in calculating a share degree in Embodiment 1 of the present invention. More specifically, in the examples of FIG. 4, one rule is formed by associating a rule ID, a situational expression, a pattern of a corresponding expression associated with the situational expression and a share degree with one another. Note that in the examples of FIG. 4, a set of the root forms of parts of speech is presented as situational expressions as with the examples of FIG. 3. A pair consisting of the asterisk sign “*” and a character string is presented as a corresponding expression associated with a situational expression. The asterisk sign “*” is to be replaced with an arbitrary word or character string.

Furthermore, the rules may define cases as character strings assumed as corresponding expressions. More specifically, the rules may check whether or not corresponding expressions match information of cases such as surface cases and deep cases as a requirement. For example, when a field of a corresponding expression shows the rule “* (wo),” it means that the rule checks whether or not the corresponding expression matches the Japanese “case of wo,” and therefore the shared state analysis unit 102 determines whether or not the corresponding expression is equivalent to an accusative case.

As mentioned earlier, a share degree is a measure of the possibility that an event is shared by a plurality of people, that is to say, “the shared state of an event.” In the examples of FIG. 4, a share degree is a score that numerically indicates the extent of the possibility that an event is shared by a plurality of people, that is to say, the level of the shared state of an event. For example, a share degree may be expressed using a binary number 1 or 0, or may be expressed using a real number in a range from 0 to 1. The level of a share degree calculated using the rules may be obtained in advance based on, for example, dictionary information related to situational expressions and corresponding expressions that are required in the application of the rules, or the usage in an actual corpus of documents.

A share degree expressed using a binary number indicates whether or not an event is shared. On the other hand, a share degree expressed using a real number indicates a higher level of the shared state of an event to which the corresponding rule applies as it is closer to 1, and conversely indicates a lower level of the shared state of the event as it is closer to 0.

For example, assume that the description “I went to the Osaka music festival” is contained in a document. This document contains the verb “went.” By changing this part of speech into the root form, “go” is identified as a situational expression, and accordingly it can be determined that there is an event description related to “go.” This situational expression is equivalent to the situational expression “go” associated with the rule ID “3.” Furthermore, “I” and “to the Osaka music festival” are identified as two corresponding expressions associated with “went.” The latter, “to the Osaka music festival,” is equivalent to the corresponding constituent element “* music festival” associated with the rule ID “3.” Therefore, this event description related to the situational expression “go” matches the rule ID “2,” and a share degree thereof can be analyzed to be “0.92.”

As another example, assume that the description “ate curry (curry wo tabeta)” is contained in a document. In this case, “curry (curry wo)” and “ate (tabeta)” respectively match the corresponding expression and situational expression associated with the rule ID “102,” and therefore the share degree can be analyzed to be “0.12.” In general, the action of eating is often performed by a single subject. Therefore, the level of the shared state of such an action is considered to be low, and a share degree thereof is set to a value close to 0.

Another specific example of step A4 is described below. For example, assume that the situational expressions and corresponding expressions shown in FIG. 3 are obtained in step A3. In this case, the shared state analysis unit 102 may calculate a first degree indicating the possibility that an object of a situational expression is shared by a plurality of people and second degrees indicating the possibilities that corresponding expressions representing a place, a subject and an object are related to an event, so as to calculate a final “share degree” based on the calculated first and second degrees.

For example, the shared state analysis unit 102 calculates a second degree for each of the place, subject and object, and identifies one of the calculated second degrees with the largest value. Then, the shared state analysis unit 102 multiplies the identified second degree with the largest value by the first degree, and determines a value obtained through multiplication to be the share degree.

A description is now given of the first and second degrees using specific examples. A first degree can be calculated by comparing a situational expression indicating a behavior, an action or a status with a precomposed dictionary. This dictionary can be composed by setting a value that serves as a first degree for each situational expression in advance.

More specifically, the objects of the actions or statuses of the expressions “eat,” “have,” “make,” “cook,” “buy,” “sleep” and “wake up” are difficult to be shared between a specific subject and another subject. Such expressions are exclusive in nature. Therefore, the possibility that the objects of such expressions are shared by a plurality of people is low. Accordingly, such expressions are assigned values close to 0 in the dictionary

Similarly, it can be generally said that the following actions have a low possibility of being shared by a plurality of people: personal actions related to daily lives of different individuals or subjects, and actions of consuming and expending objects in accordance with such personal actions (for example, food in the case of “eating”).

A share degree may be calculated for each action by associating an expression indicating the action appearing in an actual corpus of documents with subjects that are involved with the action using an existing language analysis technique, and counting the number of the subjects that are involved with the action. Alternatively, a share degree may be estimated by obtaining the usage of each expression from a dictionary or similar information. Alternatively, expressions that are frequently used in reports or descriptions on events that have a high possibility of being shared by a plurality of people, such as “hold,” “announce,” “report” and “participate,” may be used as clue expressions. In this case, a share degree of each expression may be calculated based on the frequency at which the expression is in a co-occurrence or dependency relationship with those clue expressions in an actual corpus of documents.

On the other hand, it is considered that the objects of the actions or statuses of the expressions “meet,” “see,” “go see,” “participate,” “come,” “hold,” “take place,” “held,” “gather” and “welcome” can easily be shared between a specific subject and another subject. In general, a share degree of an expression related to the act of viewing and listening by a certain subject, and a share degree of an action that is not repeated on a daily basis, are estimated to be high. Therefore, share degrees of such expressions are assigned values close to 1. Share degrees of such expressions may be calculated based on the frequency at which such expressions are in a co-occurrence or dependency relationship with expressions indicating an event related to the same object with which different subjects were involved in an actual corpus of documents.

A second degree can also be calculated by comparing a corresponding expression with a precomposed dictionary. This dictionary can be composed by setting a value that serves as a second degree for each corresponding expression in advance. A second degree may be calculated based on the frequency at which a corresponding expression is in a co-occurrence or dependency relationship with an expression indicating an event related to the same object in an actual corpus of documents.

More specifically, in the case where a corresponding expression representing a place or an object is a common noun, the possibility that the corresponding expression is related to an event is considered to be low, and accordingly the second degree thereof is set to 0. Conversely, in the case where a corresponding expression is a proper noun or a specific condition, the possibility that the corresponding expression is related to an event is considered to be high, and accordingly the first degree thereof is set to 1.

More specifically, in the case where a corresponding expression representing a place is the word “mountain,” as it is a common noun that does not identify a specific mountain, the second degree thereof is set to 0. On the other hand, in the case where a corresponding expression representing a place is the word “Mount Fuji,” the possibility that the corresponding expression is related to an event is considered to be high because it refers to a specific mountain, i.e. Mount Fuji and could be shared by a plurality of subjects at specific time. Accordingly, the second degree thereof is set to 1.

Also, for example, in the case where a corresponding expression representing a place refers to a large area such as “Japan” and “the Kanto region,” as that area is assumed to be involved with a plurality of different events, the possibility that the corresponding expression is related to a specific event is considered to be low. Accordingly, the second degree thereof is set to a value close to 0. On the other hand, in the case where a corresponding expression representing a place refers to a specific place such as “Yokohama Station” and “the Port of Yokohama,” the possibility that the corresponding expression is related to a specific event is considered to be high, and accordingly the second degree thereof is set to a value close to 1. Note that the second degree of a corresponding expression representing a place may be determined based on the area or volume thereof.

The same goes for a corresponding expression representing an object. For example, when a corresponding expression representing an object is “sushi,” it does not identify a specific type of “sushi,” i.e. by whom it was prepared and what kind of features it has. Therefore, it is considered that “sushi” is common and has a low possibility of being related to an event. Accordingly, the share degree thereof is set to a value close to 0. On the other hand, when a corresponding expression representing an object is “sushi of Tanaka Sushi Shop,” it narrows down to the specific chefs, the level of the shared state thereof is high, and it has a high possibility of being related to an event. Accordingly, the second degree thereof is set to a value close to 1.

The same goes for a corresponding expression representing a subject. For example, when a corresponding expression representing a subject refers to one individual, it has a low possibility of being related to an event. Accordingly, the second degree thereof is set to a value close to 0. On the other hand, when a corresponding expression representing a subject refers to an organization, a group, or other entities that could contain a plurality of subjects, it has a high possibility of being related to an event. Accordingly, the second degree thereof is set to a value close to 1. Similarly, when a corresponding expression contains a clue expression that implies an action by a plurality of subjects, such as “together,” “with everyone” and “in a group,” the second degree thereof is assigned a value close to 1.

(Step A5)

In step A5, the analysis result output unit 103 outputs the result of analysis obtained in step A4, that is to say, information related to an event and the calculated share degree. Examples of information related to an event are situational expressions and corresponding expressions. More specifically, with regard to the event description “I went to the Osaka music festival” in a certain document, the analysis result output unit 103 outputs a situational expression, corresponding expression and share degree in the form of a list, e.g. “situational expression: went, constituent element: to the Osaka music festival, share degree: 0.92.”

Other examples of information related to an event are sentences containing situational expressions and corresponding expressions. For example, the analysis result output unit 103 may output a sentence and a share degree as the result of analysis as follows: “I went to the Osaka music festival: 0.92.”

Furthermore, the analysis result output unit 103 may output information indicating whether or not an event is shared as a share degree. For example, the analysis result output unit 103 may output a sentence that serves as information related to an event (event description) and information indicating whether or not the event is shared as the result of analysis as follows: “I went to the Osaka music festival: Shared.”

Also, the analysis result output unit 103 may output titles such as a place, a subject, an object and a situational expression, together with the details thereof, as information related to an event. For example, the analysis result output unit 103 may output a set of titles and the details thereof in the form of a list, e.g. “place: Osaka, subject: I, object: Osaka music festival, situational expression: went, share degree: 0.92,” as the result of analysis.

Furthermore, the analysis result output unit 103 may be configured to output information related to an event as the result of analysis only when the share degree of the event is 1 or is greater than or equal to a threshold. In this case, information related to an event is not output when the share degree of the event is low.

### Effects of Embodiment 1

As set forth above, in the present Embodiment 1, a share degree is calculated for an event described in a document. The share degree is high when the event has a high possibility of being shared by a plurality of people, and low when the event has a low possibility of being shared by a plurality of people. Therefore, the event analysis apparatus 100 takes into consideration whether or not the event is attracting interest from a plurality of people based on the share degree. In this way, when random discrete expressions related to events contain matching portions, it is easy to distinguish between the case where a plurality of people seem to be mutually discussing events and the case where a plurality of people have actually picked up a specific event as a topic. Therefore, event analysis can be performed with high accuracy.

### Embodiment 2

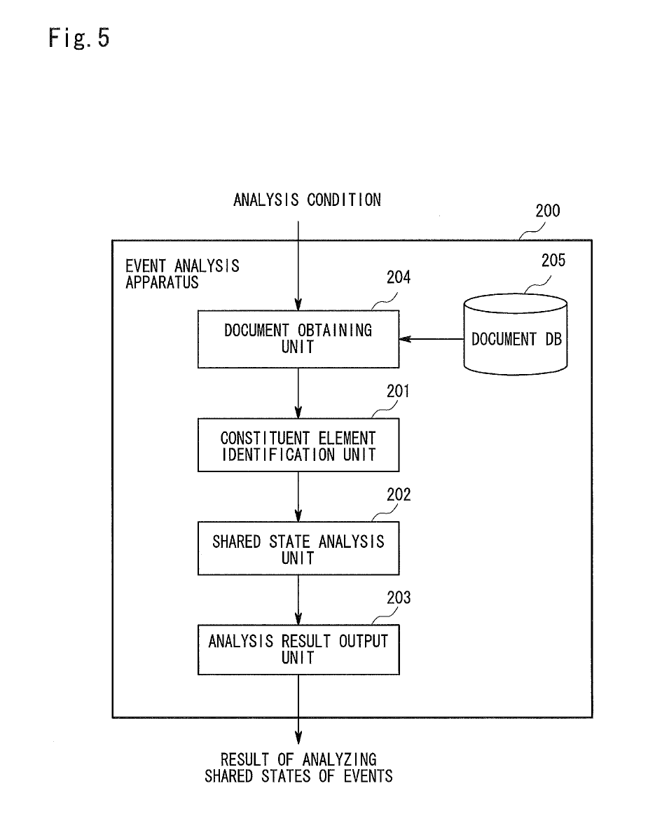

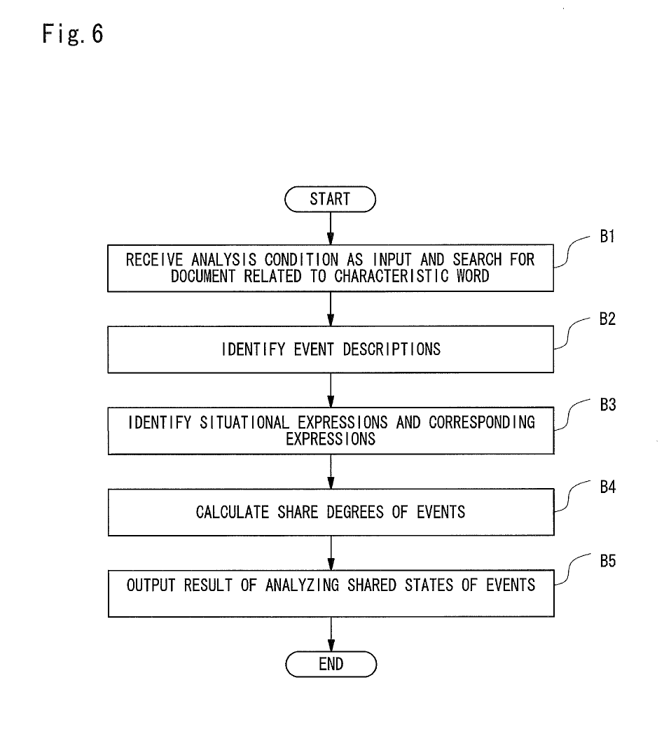

The following describes an event analysis apparatus and an event analysis method according to Embodiment 2 of the present invention with reference to FIGS. 5 and 6. While Embodiment 2 of the present invention is described below, the present invention is by no means limited to the following Embodiment 2.

Apparatus Configuration

First, a description is given of a configuration of the event analysis apparatus according to Embodiment 2 of the present invention with reference to FIG. 5. FIG. 5 is a block diagram showing a schematic configuration of the event analysis apparatus according to Embodiment 2 of the present invention.

As shown in FIG. 5, an event analysis apparatus 200 according to the present Embodiment 2 includes a constituent element identification unit 201, a shared state analysis unit 202, an analysis result output unit 203, a document obtaining unit 204, and a document database (hereinafter referred to as “document DB”) 205.

The document obtaining unit 204 receives an analysis condition as input and obtains, from a set of documents prepared in advance, one or more documents that match the analysis condition received as input. Examples of the analysis condition include one or more keywords and a specific time period. Note that in the present Embodiment 2, the set of documents is prepared in the document DB 205.

In the present Embodiment 2, the constituent element identification unit 201 analyzes one or more documents obtained by the document obtaining unit 204. Other than the fact that the constituent element identification unit 201 analyzes one or more documents obtained by the document obtaining unit 204, the constituent element identification unit 201 operates in a manner similar to the constituent element identification unit 101 shown in FIG. 1. Therefore, the constituent element identification unit 201 also identifies event descriptions and further identifies situational expressions and corresponding expressions from the identified event descriptions.

The shared state analysis unit 202 operates in a manner similar to the shared state analysis unit 102 shown in FIG. 1. That is to say, the shared state analysis unit 202 calculates share degrees indicating the shared states of events based on the situational expressions and corresponding expressions identified by the constituent element identification unit 201.

In the present Embodiment 2, the analysis result output unit 203 outputs the analysis condition in addition to the share degrees and information related to the events. Furthermore, as will be described later, the analysis result output unit 203 can also perform ranking based on the share degrees depending on the analysis condition that the document obtaining unit 204 received as input. Note that the analysis result output unit 203 may operate in a manner similar to the analysis result output unit 103 shown in FIG. 1.

Apparatus Operations

A description is now given of the operations of the event analysis apparatus 200 according to Embodiment 2 of the present invention with reference to FIG. 6. FIG. 6 is a flow diagram showing the operations of the event analysis apparatus according to Embodiment 2 of the present invention. In the following description, FIG. 5 shall be referred to where appropriate. In the present Embodiment 2, the event analysis method is implemented by causing the event analysis apparatus 200 to operate. Therefore, the following description of the operations of the event analysis apparatus 200 applies to the event analysis method according to the present Embodiment 2.

As shown in FIG. 6, when the document obtaining unit 204 receives an analysis condition as input, the document obtaining unit 204 searches the document DB 205 based on the analysis condition and obtains one or more documents that match the analysis condition (step B1). The document obtaining unit 204 also inputs the obtained one or more documents to the constituent element identification unit 201.

In step B1, the analysis condition is, for example, one or more keywords. In this case, the input one or more keywords are the words that represent the characteristics of one or more documents to be obtained (hereinafter also referred to as “characteristic words”). Then, for each characteristic word, the document obtaining unit 204 obtains one or more documents using the characteristic word.

Alternatively, in step B1, the analysis condition may be a specific time period. In this case, the document obtaining unit 204 receives a target time period instead of one or more keywords as input. More specifically, the document obtaining unit 204 receives a time period identified by the issue date and time as the analysis condition.

For example, the document obtaining unit 204 receives, as the analysis condition, a condition that defines a time period from the start date and time to the end date and time, or a condition that defines the start date and time and the length of a time period. The document obtaining unit 204 then obtains one or more documents that match the condition defining the specific time period from the document DB 205.

In the case where the analysis condition is a specific time period, the document obtaining unit 204 may determine one or more characteristic keywords as “characteristic words” based on the input time period, and obtain, for each characteristic word determined, one or more documents related to the characteristic word from the document DB 205.

For example, the document obtaining unit 204 calculates, from a set of documents issued during a specific time period (e.g., every hour), indexes such as frequencies and tf−idf values of words contained in the set of documents. The document obtaining unit 204 then compares each word with words that appeared therebefore and thereafter in terms of time, and determines, for example, whether or not a difference in or an increase rate of the indexes exceeds a specific threshold. Thereafter, the document obtaining unit 204 determines the words for which the indexes exceed the specific threshold to be characteristic keywords that have suddenly increased, and uses these words as characteristic words.

In the present Embodiment 2, it is preferable that each document be stored in the document DB 205 together with the issue date and time. For example, in the case where webpages such as news, electronic bulletin boards, blogs and microblogs are collected, these collected webpages are stored in the document DB 205 as documents with the issue dates and times assigned thereto. Note that the issue dates and times are obtained from time of collection, time information described in the webpages, and the like.

In this case, when searching for one or more documents, the document obtaining unit 204 may obtain the issue dates and times in addition to the result of the search. Also, the document obtaining unit 204 may restrict the target of the search to a set of documents issued during a specific time period and execute processing only for the set of documents issued during that time period. Also, the document obtaining unit 204 may receive, as input, a logical conjunction combining the following conditions: one or more keywords and a specific time period.

Next, the constituent element identification unit 201 receives, from the document obtaining unit 204, the analysis condition and one or more documents obtained by the document obtaining unit 240, and identifies, for each document received, one or more event descriptions contained in the document (step B2). Thereafter, the constituent element identification unit 101 identifies situational expressions and corresponding expressions from the event descriptions (step B3). Note that steps B2 and B3 are similar to steps A2 and A3 shown in FIG. 2, respectively.

Subsequently, the shared state analysis unit 202 calculates share degrees indicating the shared states of events based on the situational expressions and corresponding expressions identified from the event descriptions (step B4). Note that step B4 is similar to step A4 shown in FIG. 2.

Then, the analysis result output unit 203 receives the share degrees and information related to the events from the shared state analysis unit 202, receives the analysis condition from the document obtaining unit 204, and externally outputs the received share degrees, information and analysis condition as a result of analyzing the shared states of the events (step B4).

For example, assume that in response to the input of the keyword “Osaka music festival” as the analysis condition, the constituent element identification unit 101 identifies n event descriptions and the shared state analysis unit 202 calculates a share degree for each event description. In this case, the analysis result output unit 203 outputs the keyword (characteristic word), information related to the n event descriptions, and the share degrees. That is to say, in this case, the analysis result output unit 203 executes step A5 according to Embodiment 1 shown in FIG. 2 for each event description.

In the present Embodiment 2, the analysis result output unit 203 may output the result of analysis for each characteristic word when a plurality of keywords are input as characteristic words in step B1, or when a plurality of characteristic words are determined depending on an input time period.

Furthermore, when there are a plurality of characteristic words, the analysis result output unit 203 may also rank the characteristic words based on the share degrees thereof and output the result of ranking together with the characteristic words. In this case, the ranking is determined as follows: scores are calculated based on the share degrees, and a characteristic word with a higher score is ranked higher.

Furthermore, when there are a plurality of characteristic words, the analysis result output unit 203 may calculate a score by summing the share degrees of the characteristic words and output the obtained score together with the characteristic words. In this case, instead of summing the share degrees, the analysis result output unit 203 may identify the largest value of the share degrees and use the identified largest value as a score.

### Effects of Embodiment 2

As set forth above, in the present Embodiment 2, a specific keyword and a specific time period are input as an analysis condition, and the result of analysis of event descriptions obtained in view of the analysis condition is output. Therefore, the analysis is applied to events that exhibit a high level of shared state in view of the analysis condition. Furthermore, according to the present Embodiment 2, share degrees calculated for a plurality of characteristic words can be compared with one another. Moreover, by performing ranking, events and characteristic words that exhibit a low level of shared state can be filtered. The application of the present Embodiment 2 makes it possible to achieve the effects similar to the effects achieved by Embodiment 1.

### Programs According to Embodiments

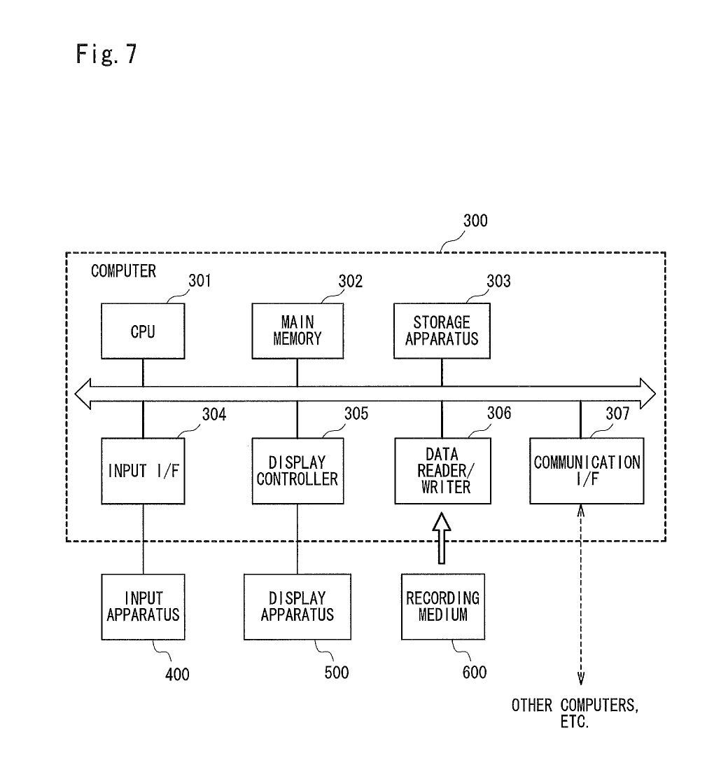

A description is now given of programs according to Embodiments 1 and 2. A computer that can execute the programs according to Embodiments 1 and 2 is also described below with reference to FIG. 7. FIG. 7 is a block diagram showing one example of a computer that realizes the event analysis apparatuses according to Embodiments 1 and 2 of the present invention.

As shown in FIG. 7, a computer apparatus 300 includes a central processing unit (CPU) 301, a random-access memory (RAM) 302, a storage apparatus 303, an input interface circuit (input I/F) 304, a display controller 305, a data reader/writer 306, and a communication interface circuit (communication I/F) 307. The storage apparatus 303 is a large-capacity storage apparatus such as a magnetic disk storage apparatus and a solid-state drive (SSD).

As shown in FIG. 7, an input apparatus 400 such as a keyboard and a mouse is connected to the input interface circuit 304. Also, other computers are connected to the communication interface circuit 307 via a communication network. Furthermore, a display apparatus 500 is connected to the display controller 305. The data reader/writer 306 receives data from an external recording medium 600 as input, and outputs data to the external recording medium 600.

By installing and executing steps A1 to A5 shown in FIG. 2 on the computer 300, the event analysis apparatus 100 according to Embodiment 1 is realized by the computer 300. In this case, the CPU 301 functions as the constituent element identification unit 101, shared state analysis unit 102 and analysis result output unit 103 and executes processing thereof.

Similarly, by installing and executing steps B1 to B5 shown in FIG. 6 on the computer 300, the event analysis apparatus 200 according to Embodiment 2 is realized by the computer 300. In this case, the CPU 301 functions as the constituent element identification unit 201, shared state analysis unit 202, analysis result output unit 203 and document obtaining unit 204 and executes processing thereof. The storage apparatus 303 functions as the document DB 205.

Note that in the example of FIG. 7, the document DB 205 may be realized by mounting a recording medium having recorded therein a large number of electronic documents on a reading apparatus 600. Also, the document DB 205 may be realized by other computer apparatuses that are connected to the computer apparatus 300 via a network.

Furthermore, the program for causing the computer apparatus 300 to execute steps A1 to A5 shown in FIG. 2 and the program for causing the computer apparatus 300 to execute steps B1 to B5 shown in FIG. 6 are stored in, for example, the computer-readable recording medium 600. The programs stored in the recording medium 600 are installed on the computer apparatus 300 via the reader/writer 306 which is a reading apparatus such as an optical drive apparatus. These programs may be distributed over the Internet connected via the communication interface circuit 307.

In the example of FIG. 7, the input interface circuit 304 and the communication interface circuit 307 function as input units for the constituent element identification unit 101 or 201. Furthermore, the display controller 305 and the communication interface circuit 307 function as output units when the analysis result output unit 103 or 203 outputs data to the outside.

Also, in the example of FIG. 7, parts of storage areas of the RAM 302 and storage apparatus 303 are used as temporary storage areas for, for example, the intermediate result of processing steps executed by the event analysis apparatus 100 or 200. Furthermore, parts of storage areas of the RAM 302 and storage apparatus 303 may be used as data storage areas for the document DB 205.

Specific examples of the computer-readable recording medium 600 include a general-purpose semiconductor storage apparatus such as CompactFlash (CF, registered trademark) and Secure Digital (SD), a magnetic storage medium such as a flexible disk, and an optical storage medium such as a Compact Disc read-only memory (CR-ROM).

A part or all of the above embodiments can be described as, but are not limited to, the following Notes 1 to 30.

(Note 1)

An event analysis apparatus that analyzes an event described in a document targeted for analysis, including: a constituent element identification unit that identifies a description related to an event from the document targeted for analysis, and identifies a situational expression indicating a situation and a corresponding expression associated with the situational expression from the identified description; and a shared state analysis unit that calculates a share degree indicating the possibility that the event to which the description is related is shared by a plurality of people based on the situational expression and the corresponding expression identified from the description.

(Note 2)

The event analysis apparatus according to Note 1, further including an analysis result output unit that outputs the share degree and information related to the event for which the share degree has been calculated.

(Note 3)

The event analysis apparatus according to Note 1 or 2, wherein the constituent element identification unit identifies a portion of the identified description indicating a behavior, an action or a status as the situational expression, and identifies an expression that is related to the situational expression and represents any of a time, a place, a subject and an object as the corresponding expression.

(Note 4)

The event analysis apparatus according to any of Notes 1 to 3, wherein the shared state analysis unit calculates the share degree by applying set rules to the situational expression and the corresponding expression identified from the description; and the rules define share degrees in one-to-one association with pairs each consisting of an assumed situational expression and a character string assumed as a corresponding expression associated with the situational expression.

(Note 5)

The event analysis apparatus according to Note 4, wherein the rules further define a case as a character string assumed as a corresponding expression associated with the situational expression; and the shared state analysis unit applies the rules when the corresponding expression matches the case defined by the rules.

(Note 6)

The event analysis apparatus according to any of Notes 1 to 3, wherein the shared state analysis unit calculates a first degree indicating the possibility that an object of the situational expression is shared by a plurality of people and a second degree indicating the possibility that the corresponding expression is related to the event, and calculates the share degree based on the first degree and the second degree.

(Note 7)

The event analysis apparatus according to Note 2, wherein the analysis result output unit outputs either the situational expression and the corresponding expression, or a sentence containing the situational expression and the corresponding expression, as the information related to the event for which the share degree has been calculated.

(Note 8)

The event analysis apparatus according to Note 2, further including a document obtaining unit that receives an analysis condition as input, and obtains, from a set of documents prepared in advance, one or more documents that match the analysis condition received as input, wherein the constituent element identification unit uses the one or more documents obtained by the document obtaining unit as the document targeted for analysis; and the analysis result output unit outputs the analysis condition in addition to the share degree and the information related to the event for which the share degree has been calculated.

(Note 9)

The event analysis apparatus according to Note 8, wherein one or more keywords or a specific time period is input as the analysis condition.

(Note 10)

The event analysis apparatus according to Note 8, wherein the document obtaining unit determines one or more characteristic words based on the analysis condition received as input, and obtains one or more documents for each characteristic word determined; the shared state analysis unit calculates the share degree for each characteristic word; and when the number of the characteristic words is two or more, the analysis result output unit either outputs a value obtained by summing the share degrees for the characteristic words and the characteristic words, or ranks the characteristic words based on the share degrees therefor and outputs a result of the ranking and the characteristic words.

(Note 11)

An event analysis method for analyzing an event described in a document targeted for analysis, including: (a) a step of identifying a description related to an event from the document targeted for analysis, and identifying a situational expression indicating a situation and a corresponding expression associated with the situational expression from the identified description; and (b) a step of calculating a share degree indicating the possibility that the event to which the description is related is shared by a plurality of people based on the situational expression and the corresponding expression identified from the description.

(Note 12)

The event analysis method according to Note 11, further including (c) a step of outputting the share degree and information related to the event for which the share degree has been calculated.

(Note 13)

The event analysis method according to Note 11 or 12, wherein step (a) identifies a portion of the identified description indicating a behavior, an action or a status as the situational expression, and identifies an expression that is related to the situational expression and represents any of a time, a place, a subject and an object as the corresponding expression.

(Note 14)

The event analysis method according to any of Notes 11 to 13, wherein step (b) calculates the share degree by applying set rules to the situational expression and the corresponding expression identified from the description; and the rules define share degrees in one-to-one association with pairs each consisting of an assumed situational expression and a character string assumed as a corresponding expression associated with the situational expression.

(Note 15)

The event analysis method according to Note 14, wherein: the rules further define a case as a character string assumed as a corresponding expression associated with the situational expression; and step (b) applies the rules when the corresponding expression matches the case defined by the rules.

(Note 16)

The event analysis method according to any of Notes 11 to 13, wherein step (b) calculates a first degree indicating the possibility that an object of the situational expression is shared by a plurality of people and a second degree indicating the possibility that the corresponding expression is related to the event, and calculates the share degree based on the first degree and the second degree.

(Note 17)

The event analysis method according to Note 12, wherein step (c) outputs either the situational expression and the corresponding expression, or a sentence containing the situational expression and the corresponding expression, as the information related to the event for which the share degree has been calculated.

(Note 18)

The event analysis method according to Note 12, further including (d) a step of receiving an analysis condition as input, and obtaining, from a set of documents prepared in advance, one or more documents that match the analysis condition received as input, wherein: step (a) uses the one or more documents obtained in step (d) as the document targeted for analysis; and step (c) outputs the analysis condition in addition to the share degree and the information related to the event for which the share degree has been calculated.

(Note 19)

The event analysis method according to Note 18, wherein the analysis condition that step (d) receives as input is one or more keywords or a specific time period.

(Note 20)

The event analysis method according to Note 18, wherein step (d) determines one or more characteristic words based on the analysis condition received as input, and obtains one or more documents for each characteristic word determined; step (b) calculates the share degree for each characteristic word; and when the number of the characteristic words is two or more, step (c) either outputs a value obtained by summing the share degrees for the characteristic words and the characteristic words, or ranks the characteristic words based on the share degrees therefor and outputs a result of the ranking and the characteristic words.

(Note 21)

A computer-readable recording medium having recorded therein a program for analyzing an event described in a document targeted for analysis using a computer, the program including an instruction for causing the computer to execute: (a) a step of identifying a description related to an event from the document targeted for analysis, and identifying a situational expression indicating a situation and a corresponding expression associated with the situational expression from the identified description; and (b) a step of calculating a share degree indicating the possibility that the event to which the description is related is shared by a plurality of people based on the situational expression and the corresponding expression identified from the description.

(Note 22)

The computer-readable recording medium according to Note 21, wherein the computer is caused to further execute (c) a step of outputting the share degree and information related to the event for which the share degree has been calculated.

(Note 23)

The computer-readable recording medium according to Note 21 or 22, wherein step (a) identifies a portion of the identified description indicating a behavior, an action or a status as the situational expression, and identifies an expression that is related to the situational expression and represents any of a time, a place, a subject and an object as the corresponding expression.

(Note 24)

The computer-readable recording medium according to any of Notes 21 to 23, wherein step (b) calculates the share degree by applying set rules to the situational expression and the corresponding expression identified from the description; and the rules define share degrees in one-to-one association with pairs each consisting of an assumed situational expression and a character string assumed as a corresponding expression associated with the situational expression.

(Note 25)

The computer-readable recording medium according to Note 24, wherein: the rules further define a case as a character string assumed as a corresponding expression associated with the situational expression; and step (b) applies the rules when the corresponding expression matches the case defined by the rules.

(Note 26)

The computer-readable recording medium according to any of Notes 21 to 23, wherein step (b) calculates a first degree indicating the possibility that an object of the situational expression is shared by a plurality of people and a second degree indicating the possibility that the corresponding expression is related to the event, and calculates the share degree based on the first degree and the second degree.

(Note 27)

The computer-readable recording medium according to Note 22, wherein step (c) outputs either the situational expression and the corresponding expression, or a sentence containing the situational expression and the corresponding expression, as the information related to the event for which the share degree has been calculated.

(Note 28)

The computer-readable recording medium according to Note 22, wherein the computer is caused to further execute (d) a step of receiving an analysis condition as input, and obtaining, from a set of documents prepared in advance, one or more documents that match the analysis condition received as input; step (a) uses the one or more documents obtained in step (d) as the document targeted for analysis; and step (c) outputs the analysis condition in addition to the share degree and the information related to the event for which the share degree has been calculated.

(Note 29)

The computer-readable recording medium according to Note 28, wherein the analysis condition that step (d) receives as input is one or more keywords or a specific time period.

(Note 30)

The computer-readable recording medium according to Note 28, wherein step (d) determines one or more characteristic words based on the analysis condition received as input, and obtains one or more documents for each characteristic word determined; step (b) calculates the share degree for each characteristic word; and when the number of the characteristic words is two or more, step (c) either outputs a value obtained by summing the share degrees for the characteristic words and the characteristic words, or ranks the characteristic words based on the share degrees therefor and outputs a result of the ranking and the characteristic words.

While the invention of the present application has been described using the above embodiments, the invention of the present application is by no means limited to the above embodiments. The configurations and details of the invention of the present application are subject to various changes that can be understood by a person skilled in the art within a scope of the invention of the present application.

The present application claims the benefit of priority from Japanese Patent Application No. 2011-63766, filed Mar. 23, 2011, the disclosure of which is incorporated herein by reference in its entirety.

### INDUSTRIAL APPLICABILITY

As set forth above, the present invention allows analyzing of events using documents in consideration of whether or not the events are attracting interest from a plurality of people. The present invention is applicable to an event information extraction apparatus that extracts information related to events from information on the Internet, an event analysis apparatus that analyzes the extracted information related to events, and an information search apparatus that can search for events that have attracted interest.

The present invention is also applicable to a clustering apparatus that forms clusters of topics so that the topics about the same event belong to the same cluster, and a clustering apparatus that forms clusters of documents containing related event descriptions. For example, such clustering apparatuses use keywords contained in event descriptions determined by the present invention or characteristic words output in Embodiment 2 as clustering features. The present invention is also applicable to processing for assigning weights to clustering features in such clustering apparatuses.

### DESCRIPTION OF REFERENCE NUMERALS

100 EVENT ANALYSIS APPARATUS (EMBODIMENT 1)

101 CONSTITUENT ELEMENT IDENTIFICATION UNIT (EMBODIMENT 1)

102 SHARED STATE ANALYSIS UNIT (EMBODIMENT 1)

103 ANALYSIS RESULT OUTPUT UNIT (EMBODIMENT 1)

200 EVENT ANALYSIS APPARATUS (EMBODIMENT 2)

201 CONSTITUENT ELEMENT IDENTIFICATION UNIT (EMBODIMENT 2)

202 SHARED STATE ANALYSIS UNIT (EMBODIMENT 2)

203 ANALYSIS RESULT OUTPUT UNIT (EMBODIMENT 2)

204 DOCUMENT OBTAINING UNIT

205 DOCUMENT DATABASE

300 COMPUTER APPARATUS

301 CPU

302 RAM

303 STORAGE APPARATUS

304 INPUT INTERFACE CIRCUIT (INPUT I/F)

305 DISPLAY CONTROLLER

306 DATA READER/WRITER

307 COMMUNICATION INTERFACE CIRCUIT (COMMUNICATION I/F)

400 INPUT APPARATUS

500 DISPLAY APPARATUS

600 RECORDING MEDIUM

What is claimed is:

1. An event analysis apparatus that analyzes an event described in a document targeted for analysis, comprising:
a constituent element identification unit that identifies a description related to an event from the document targeted for analysis, and identifies a situational expression indicating a situation and a corresponding expression associated with the situational expression from the identified description; and
a shared state analysis unit that calculates a share degree indicating the possibility that the event to which the description is related is shared by a plurality of people based on the situational expression and the corresponding expression identified from the description.

2. The event analysis apparatus according to claim 1, further comprising an analysis result output unit that outputs the share degree and information related to the event for which the share degree has been calculated.

3. The event analysis apparatus according to claim 1,
wherein the constituent element identification unit identifies a portion of the identified description indicating a behavior, an action or a status as the situational expression, and identifies an expression that is related to the situational expression and represents any of a time, a place, a subject and an object as the corresponding expression.

4. The event analysis apparatus according to claim 1,
wherein the shared state analysis unit calculates the share degree by applying set rules to the situational expression and the corresponding expression identified from the description; and
the rules define share degrees in one-to-one association with pairs each consisting of an assumed situational expression and a character string assumed as a corresponding expression associated with the situational expression.

5. The event analysis apparatus according to claim 4,
wherein the rules further define a case as a character string assumed as a corresponding expression associated with the situational expression; and
the shared state analysis unit applies the rules when the corresponding expression matches the case defined by the rules.

6. The event analysis apparatus according to claim 1, wherein the shared state analysis unit calculates a first degree indicating the possibility that an object of the situational expression is shared by a plurality of people and a second degree indicating the possibility that the corresponding expression is related to the event, and calculates the share degree based on the first degree and the second degree.

7. The event analysis apparatus according to claim 2, further comprising a document obtaining unit that receives an analysis condition as input, and obtains, from a set of documents prepared in advance, one or more documents that match the analysis condition received as input,
wherein the constituent element identification unit uses the one or more documents obtained by the document obtaining unit as the document targeted for analysis; and
the analysis result output unit outputs the analysis condition in addition to the share degree and the information related to the event for which the share degree has been calculated.

8. The event analysis apparatus according to claim 7,
wherein the document obtaining unit determines one or more characteristic words based on the analysis condition received as input, and obtains one or more documents for each characteristic word determined; the shared state analysis unit calculates the share degree for each characteristic word; and
when the number of the characteristic words is two or more, the analysis result output unit either outputs a value obtained by summing the share degrees for the characteristic words and the characteristic words, or ranks the characteristic words based on the share degrees therefor and outputs a result of the ranking and the characteristic words.

9. An event analysis method for analyzing an event described in a document targeted for analysis, comprising:
(a) a step of identifying a description related to an event from the document targeted for analysis, and identifying a situational expression indicating a situation and a corresponding expression associated with the situational expression from the identified description; and
(b) a step of calculating a share degree indicating the possibility that the event to which the description is related is shared by a plurality of people based on the situational expression and the corresponding expression identified from the description.

10. A computer-readable recording medium having recorded therein a program for analyzing an event described in a document targeted for analysis using a computer, the program comprising an instruction for causing the computer to execute:
(a) a step of identifying a description related to an event from the document targeted for analysis, and identifying a situational expression indicating a situation and a corresponding expression associated with the situational expression from the identified description; and
(b) a step of calculating a share degree indicating the possibility that the event to which the description is related is shared by a plurality of people based on the situational expression and the corresponding expression identified from the description.

11. The event analysis method according to claim 9, further comprising (c) a step of outputting the share degree and information related to the event for which the share degree has been calculated.

12. The event analysis method according to claim 9, wherein step (a) identifies a portion of the identified description indicating a behavior, an action or a status as the situational expression, and identifies an expression that is related to the situational expression and represents any of a time, a place, a subject and an object as the corresponding expression.

13. The event analysis method according to claim 9, wherein step (b) calculates the share degree by applying set rules to the situational expression and the corresponding expression identified from the description; and the rules define share degrees in one-to-one association with pairs each consisting of an assumed situational expression and a character string assumed as a corresponding expression associated with the situational expression.

14. The event analysis method according to claim 13, wherein: the rules further define a case as a character string assumed as a corresponding expression associated with the situational expression; and step (b) applies the rules when the corresponding expression matches the case defined by the rules.

15. The event analysis method according to claim 9, wherein step (b) calculates a first degree indicating the possibility that an object of the situational expression is shared by a plurality of people and a second degree indicating the possibility that the corresponding expression is related to the event, and calculates the share degree based on the first degree and the second degree.

16. The event analysis method according to claim 11, further comprising (d) a step of receiving an analysis condition as input, and obtaining, from a set of documents prepared in advance, one or more documents that match the analysis condition received as input, wherein: step (a) uses the one or more documents obtained in step (d) as the document targeted for analysis; and step (c) outputs the analysis condition in addition to the share degree and the information related to the event for which the share degree has been calculated.

17. The event analysis method according to claim 16, wherein step (d) determines one or more characteristic words based on the analysis condition received as input, and obtains one or more documents for each characteristic word determined;
step (b) calculates the share degree for each characteristic word; and when the number of the characteristic words is two or more, step (c) either outputs a value obtained by summing the share degrees for the characteristic words and the characteristic words, or ranks the characteristic words based on the share degrees therefor and outputs a result of the ranking and the characteristic words.

18. The computer-readable recording medium according to claim 10, wherein the computer is caused to further execute (c) a step of outputting the share degree and information related to the event for which the share degree has been calculated.

19. The computer-readable recording medium according to claim 10, wherein step (a) identifies a portion of the identified description indicating a behavior, an action or a status as the situational expression, and identifies an expression that is related to the situational expression and represents any of a time, a place, a subject and an object as the corresponding expression.

20. The computer-readable recording medium according to claim 10, wherein step (b) calculates the share degree by applying set rules to the situational expression and the corresponding expression identified from the description; and the rules define share degrees in one-to-one association with pairs each consisting of an assumed situational expression and a character string assumed as a corresponding expression associated with the situational expression.

21. The computer-readable recording medium according to claim 20, wherein:
the rules further define a case as a character string assumed as a corresponding expression associated with the situational expression; and step (b) applies the rules when the corresponding expression matches the case defined by the rules.

22. The computer-readable recording medium according to claim 10, wherein step (b) calculates a first degree indicating the possibility that an object of the situational expression is shared by a plurality of people and a second degree indicating the possibility that the corresponding expression is related to the event, and calculates the share degree based on the first degree and the second degree.

23. The computer-readable recording medium according to claim 18, wherein the computer is caused to further execute (d) a step of receiving an analysis condition as input, and obtaining, from a set of documents prepared in advance, one or more documents that match the analysis condition received as input; step (a) uses the one or more documents obtained in step (d) as the document targeted for analysis; and step (c) outputs the analysis condition in addition to the share degree and the information related to the event for which the share degree has been calculated.

24. The computer-readable recording medium according to claim 23, wherein step (d) determines one or more characteristic words based on the analysis condition received as input, and obtains one or more documents for each characteristic word determined; step (b) calculates the share degree for each characteristic word; and when the number of the characteristic words is two or more, step (c) either outputs a value obtained by summing the share degrees for the characteristic words and the characteristic words, or ranks the characteristic words based on the share degrees therefor and outputs a result of the ranking and the characteristic words.
